(19) United States
(12) Patent Application Publication
(10) Pub. No.: US 2011/0074744 A1
(43) Pub. Date: Mar. 31, 2011

(54) ELECTRON-EMITTING DEVICE, DISPLAY PANEL, AND IMAGE DISPLAY APPARATUS

(75) Inventors: Satoru Nitobe, Hiratsuka-shi (JP); Takashi Shiozawa, Hiratsuka-shi (JP); Takanori Suwa, Kawasaki-shi (JP); Shigeyuki Takagi, Fujisawa-shi (JP); Toshiharu Sumiya, Ebina-shi (JP)

(73) Assignee: CANON KABUSHIKI KAISHA, Tokyo (JP)

(21) Appl. No.: 12/890,395

(22) Filed: Sep. 24, 2010

(30) Foreign Application Priority Data
Sep. 28, 2009 (JP) 2009-222513(PAT.)

(51) Int. Cl. G09G 5/00; H01J 9/02

(52) U.S. Cl. 345/204; 313/310

(57) ABSTRACT

Provided is an electron-emitting device including an insulating member and a gate stacked on a substrate. A cathode is disposed on a side surface of the insulating member. The cathode has a plurality of protrusions provided along a corner of the insulating member. The gate has a plurality of protrusions extending toward the cathode.

### BACKGROUND OF THE INVENTION

1. Field of the Invention

The present invention relates to an electron-emitting device for use in a display or the like.

2. Description of the Related Art

A field emission type electron-emitting device is known in which a majority of electrons field-emitted from one of a pair of opposing conductive films collides with the other conductive film, are scattered, and thereafter reaches an anode. Japanese Patent Laid-Open No. 2001-167693 discloses an electron-emitting device in which an insulating layer is disposed between a pair of conductive films, and depressions are provided on the surface of the insulating layer. Japanese Patent Laid-Open No. 2006-185820 discloses an electron-emitting device in which depressions and protrusions are provided on the surface of the conductive film.

### SUMMARY OF THE INVENTION

An electron-emitting device according to an aspect of the present invention includes an insulating member including an upper surface and a side surface connected to the upper surface; a cathode extending from a first part of the upper surface to the side surface and including a first plurality of protrusions disposed along a boundary between the upper surface and the side surface; and a gate including a base connected to a second part of the insulating member and a second plurality of protrusions each protruding from the base toward the cathode and forming a gap between the second plurality of protrusions and the first plurality of protrusions.

Further features of the present invention will become apparent from the following description of exemplary embodiments with reference to the attached drawings.

### BRIEF DESCRIPTION OF THE DRAWINGS

FIG. 1A is a schematic plan view of an electron-emitting device according to an embodiment of the present invention.

FIG. 1B is a cross-sectional view taken on line IB-IB in FIG. 1A and FIG. 1D.

FIG. 1C is a cross-sectional view taken on line IC-IC in FIG. 1A and FIG. 1D.

FIG. 1D is a side view of the electron-emitting device of this embodiment as viewed from the right in FIG. 1A.

FIG. 2 is a schematic perspective view of an electron-emitting device according to an embodiment of the present invention.

FIG. 3A is a schematic diagram of a system that measures the electron emission characteristics.

FIG. 3B is a partial enlarged schematic diagram of FIG. 2B.

FIG. 4A is a schematic diagram illustrating the locus of an emitted electron.

FIG. 4B is a schematic diagram illustrating the locus of an emitted electron.

FIG. 5A is a graph showing the relationship between the protrusions of a gate and the electron emission efficiency.

FIG. 5B is a graph showing the relationship between the protrusions of a gate and the electron emission efficiency.

FIG. 6A is a schematic diagram illustrating an example of a method for manufacturing the electron-emitting device.

FIG. 6B is a schematic diagram illustrating the method for manufacturing the electron-emitting device.

FIG. 6C is a schematic diagram illustrating the method for manufacturing the electron-emitting device.

FIG. 6D is a schematic diagram illustrating the method for manufacturing the electron-emitting device.

FIG. 6E is a schematic diagram illustrating the method for manufacturing the electron-emitting device.

FIG. 6F is a schematic diagram illustrating the method for manufacturing the electron-emitting device.

FIG. 6G is a schematic diagram illustrating the method for manufacturing the electron-emitting device.

FIG. 6H is a schematic diagram illustrating the method for manufacturing the electron-emitting device.

FIG. 7A is a schematic diagram illustrating the process of forming a cathode and an example of the configuration of the cathode.

FIG. 7B is a schematic diagram illustrating the process of forming the cathode and an example of the configuration of the cathode.

FIG. 8 is a schematic diagram of a modification of the electron-emitting device.

FIG. 9 is a schematic cross-sectional view illustrating the process of manufacturing the modification of the electron-emitting device.

FIG. 10A is a graph showing the relationship between the protrusions of the gate of the modification and the efficiency.

FIG. 10B is a graph showing the relationship between the protrusions of the gate of the modification and the efficiency.

FIG. 11A is a schematic diagram illustrating the configuration of a display panel and a television set.

FIG. 11B is a block diagram of the television set.

FIG. 12A is a diagram showing emission current plotted against temporal changes thereof.

FIG. 12B is a diagram showing emission current plotted against temporal changes thereof.

### DESCRIPTION OF THE EMBODIMENTS

A field emission type electron-emitting device according to an embodiment will be illustrated in detail with reference to the drawings. However, it is to be understood that the sizes, materials, shapes, and the relative configurations described hereinbelow do not limit the scope of the present invention unless otherwise specified.

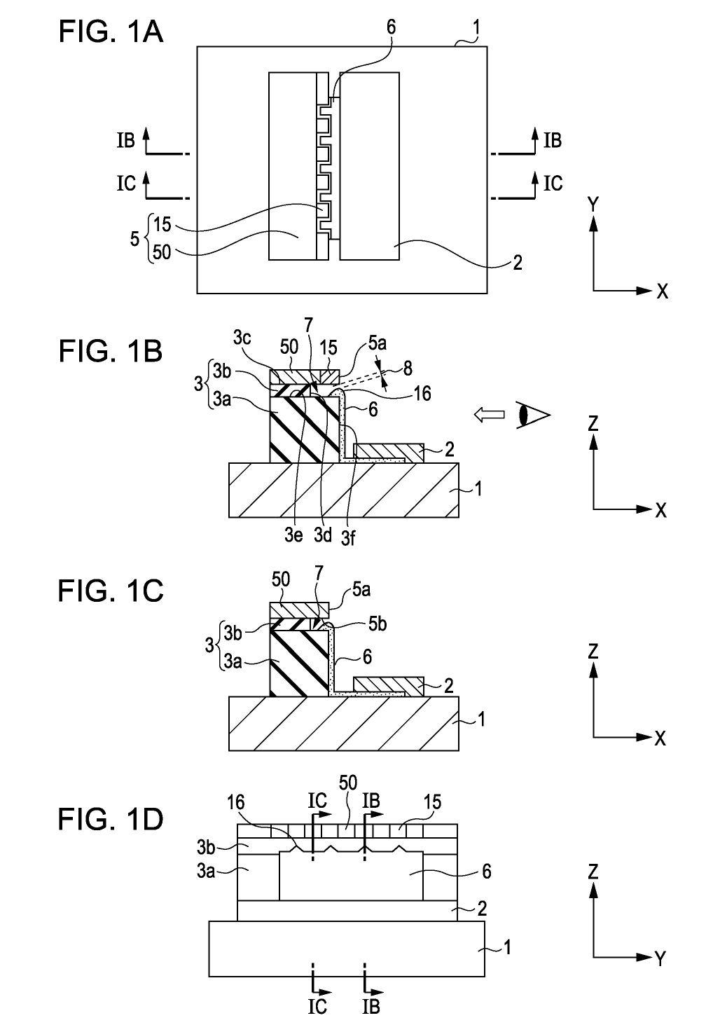

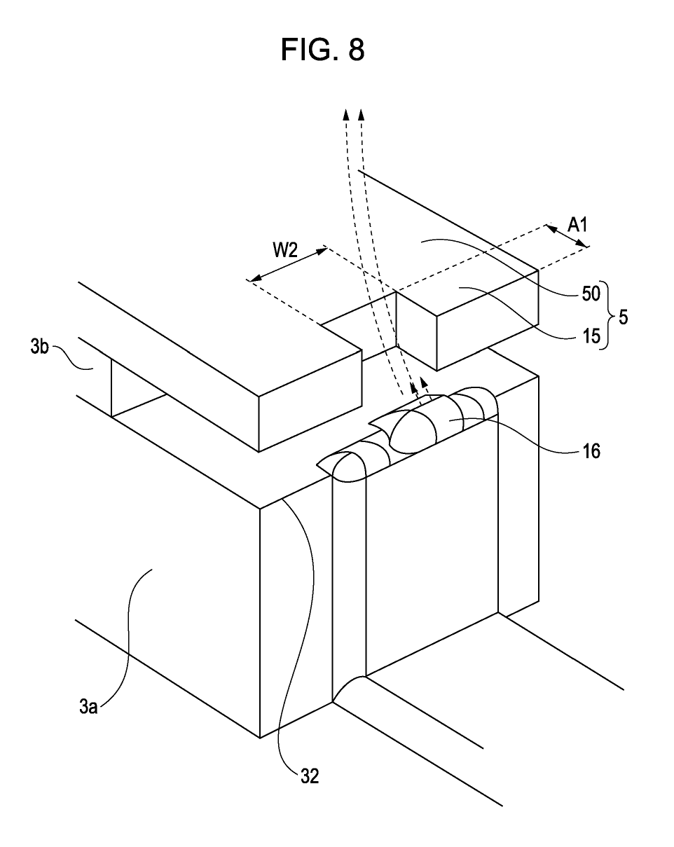

An example of the electron-emitting device of this embodiment will be described with reference to FIGS. 1A to 1D, FIG. 2, and FIG. 3B. A modification of the electron-emitting device of this embodiment will be described with reference to FIG. 8.

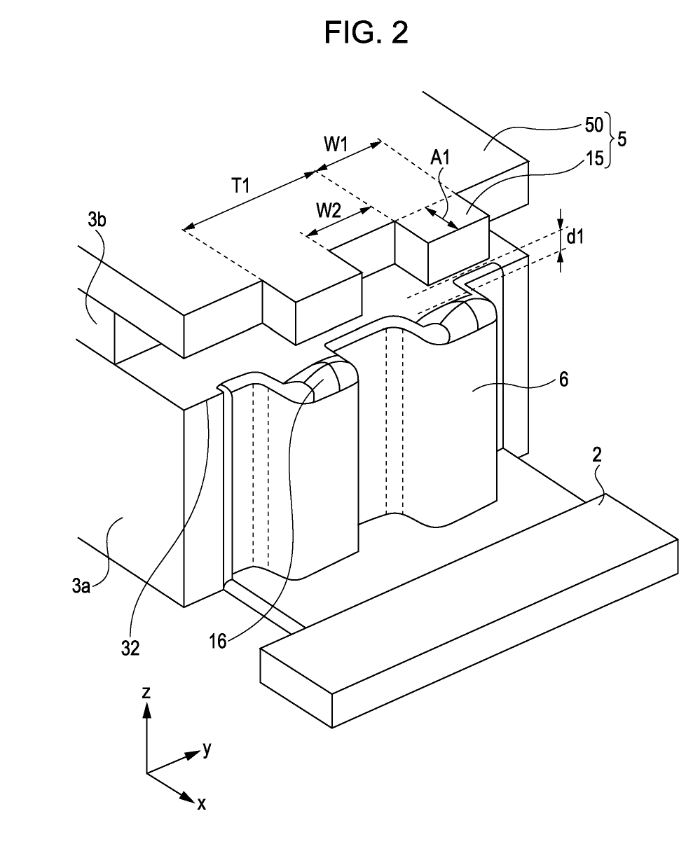

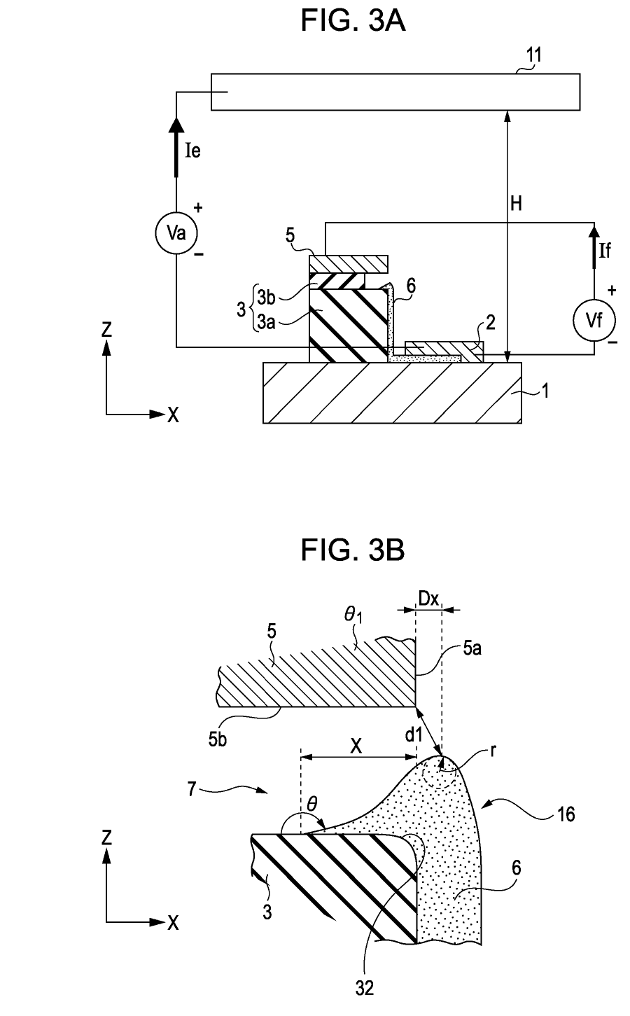

FIG. 1A is a schematic plan view of the electron-emitting device; FIG. 1B is a cross-sectional view taken on line IB-IB in FIG. 1A and FIG. 1D; FIG. 1C is a cross-sectional view taken on line IC-IC in FIG. 1A and FIG. 1D; and FIG. 1D is a side view of the electron-emitting device of this embodiment as viewed from the right in the drawing. FIG. 2 is a partially enlarged schematic perspective view of the electron-emitting device shown in FIGS. 1A to 1D. In FIG. 2, the number of protrusions 15 of a gate 5 and the number of protrusions 16 of a cathode, described below in more detail, are set at two for ease of explanation. FIG. 3B is a partial enlarged schematic diagram of FIG. 2B.

First, the overall configuration of the electron-emitting device of this embodiment will be described.

The electron-emitting device includes an insulating member 3 stacked on the surface of a substrate 1 and a gate 5 provided on the upper surface of the insulating member 3 such that the insulating member 3 is sandwiched between the gate 5 and the substrate 1. The electron-emitting device further includes a cathode 6 on a side surface of the insulating member 3. Part of the cathode 6 extends to part of the upper surface of the insulating member 3 and has a plurality of protrusions 16. The plurality of protrusions 16 are provided along a corner 32 at which the side surface and the upper surface of the insulating member 3 connect to each other. Each of the plurality of protrusions 16 corresponds to an electron-emitting portion. The gate 5 also has a plurality of protrusions 15. A gap 8 is formed between the protrusions 15 of the gate 5 and the protrusions 16 of the cathode 6. By applying voltage between the cathode 6 and the gate 5 so that the potential of the gate 5 becomes higher than the potential of the cathode 6, electrons are field emitted from the each of the plurality of protrusions 16 of the cathode 6.

The provision of the plurality of protrusions 16 on the cathode 6 allows the positions of electron emitting portions to be specified and electrons to be emitted at a lower voltage than a configuration without the protrusions 16. Furthermore, the provision of the protrusions 15 on the gate 5 can increase the rate of arrival of electrons emitted from the protrusions 16 at an anode 11, to be described below, (electron emission efficiency η) as compared with a configuration in which the protrusions 15 are not provided on the gate 5. Furthermore, the provision of the protrusions 15 on the gate 5, in addition to the provision of the protrusions 16 on the cathode 6, further ensures positioning of the electron emitting portions and increases controllability on the loci of emitted electrons as compared with a configuration in which the protrusions are provided only on the cathode 6. Thus, the range of electrons emitted to the anode 11 (electron-beam spot diameter) can be controlled.

FIGS. 1A to 1D and FIG. 2 illustrate an example in which the protrusions 15 of the gate 5 and the protrusions 16 of the cathode 6 are located on the same straight line parallel to the Z-direction (located on a line perpendicular to the surface of the substrate 1), as shown in FIGS. 1B and 1D. In other words, the protrusions 15 of the gate 5 are provided directly above the protrusions 16 of the cathode 6. However, in the present invention, the relative positional relationship between the protrusions 15 of the gate 5 and the protrusions 16 of the cathode 6 is not particularly limited. It is also possible that although the protrusions 15 of the gate 5 are located directly above the protrusions 16 of the cathode 6, as viewed from the Z-Y plane (at the angle in FIG. 1D), the protrusions 15 of the gate 5 are not be located directly above the protrusions 16 of the cathode 6, as viewed from the Z-X plane (the cross section in FIG. 1B). In other words, as in FIG. 3B, a side surface 5a or an end of the gate 5 may be located closer than the protrusions 16 of the cathode 6 (particularly, its ends) to a second insulating layer 3b. This can enhance the electron emission efficiency η as compared with a configuration in which the protrusions 15 of the gate 5 overhang directly over the protrusions 16 of the cathode 6, like eaves.

Furthermore, as in a modification of the electron-emitting device of this embodiment, shown later in detail in FIG. 8, the protrusions 16 of the cathode 6 may be disposed between two adjacent protrusions of the plurality of protrusions 15 of the gate 5. That is, the protrusions 15 of the gate 5 may be provided not directly above the protrusions 16 of the cathode 6 but diagonally above the protrusions 16 of the cathode 6. In other words, the gate 5 are not present directly above the protrusions 16 of the cathode 6 in any of cross sections perpendicular to the surface of the substrate 1 and passing the ends of the protrusions 16. With this configuration, the protrusions 16 of the cathode 6 are exposed between the two adjacent protrusions 15 of the gate 5, in plan view as in FIG. 1A. As a result, in the electron-emitting device with this configuration, the protrusions 16 are exposed to the anode 11, described below. This allows the electron-emitting device with this configuration to have higher electron emission efficiency r than the electron-emitting devices with the configuration, as shown in FIGS. 1A to 1D and FIG. 2.

Next, the insulating member 3 that constitutes the electron-emitting device will be described.

The insulating member 3 of this embodiment has a layered structure having a first insulating layer 3a and a second insulating layer 3b. However, the insulating member 3 may be formed of one insulating layer, or alternatively, may be formed of a plurality of insulating layers. With the configuration shown in FIGS. 1A to 1D, the second insulating layer 3b is stacked on part of the upper surface 3e of the first insulating layer 3a. In other words, a side surface 3d of the second insulating layer 3b is more away from the cathode 6 than a side surface 3f of the first insulating layer 3a. This allows the upper surface of the insulating member 3 to have depressions 7. Thus, the upper surface of the insulating member 3 is provided with a level difference.

The upper surface of the insulating member 3 is a surface opposing the gate 5. With the configuration shown in FIG. 1B, the upper surface of the insulating member 3 is constituted of a portion that is part of the upper surface 3e of the first insulating layer 3a and is not covered with the second insulating layer 3b, the upper surface (a surface opposing the gate 5) 3c of the second insulating layer 3b, and the side surface 3d of the second insulating layer 3b adjacent to the cathode 6. The upper surface 3e of the first insulating layer 3a and the upper surface 3c of the second insulating layer 3b are parallel to the surface of the substrate 1 if the surface of the substrate 1 is flat. Thus, the upper surface of the insulating member 3 generally includes a first surface (the upper surface of the second insulating layer 3b) and a second surface (part of the upper surface 3e of the first insulating layer 3a, not covered with the second insulating layer 3b), which are different in distance from the surface of the substrate 1. In other words, the first surface and the second surface are different in distance from the back surface 5b of the gate 5.

The insulating member 3 has a side surface 3f connecting to the upper surface of the insulating member 3. The upper surface and the side surface of the insulating member 3 do not necessarily connect to each other at right angles but may connect at an obtuse angle. Furthermore, as shown in FIG. 3B, a corner 32 at which the upper surface and the side surface of the insulating member 3 connect to each other may have a predetermined curvature. In the case where the insulating member 3 is constituted of the first insulating layer 3a and the second insulating layer 3b, the side surface of the first insulating layer 3a corresponds to the side surface of the insulating member 3.

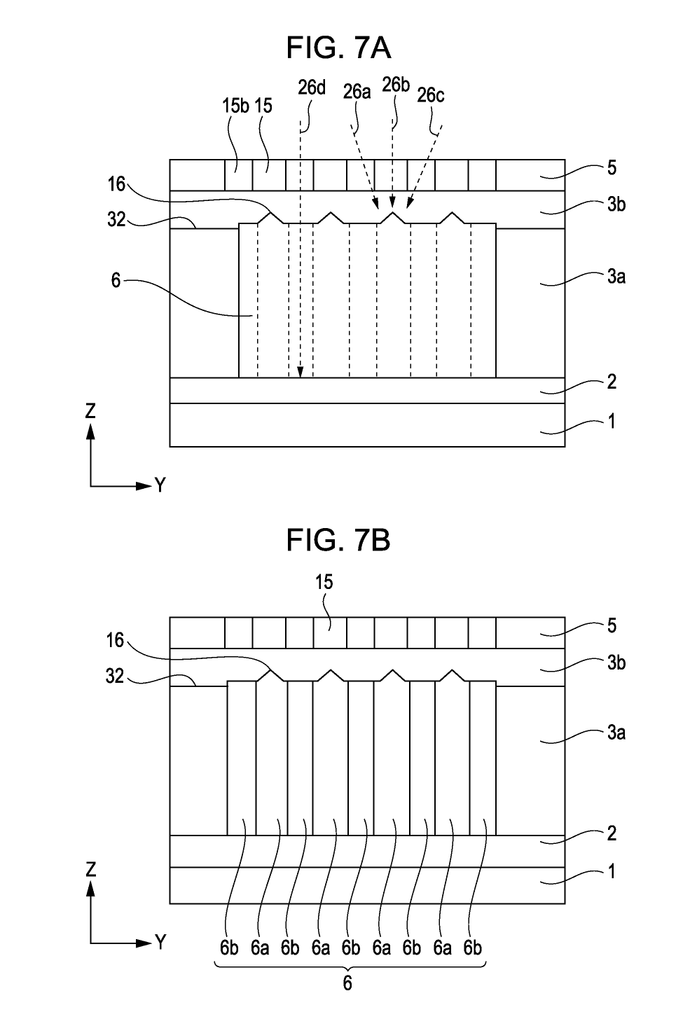

The side surface of the insulating member 3 (the side surface 3f of the first insulating layer 3a) may have a shape similar to the side surface 5a of the gate 5, to be described below (see FIGS. 1A and 2). In other words, the side surface of the insulating member 3 may have a plurality of protrusions. Since the side surface has the plurality of protrusions, the creepage distance between the plurality of protrusions 16, serving as electron emitting portions, to be described below, can be increased. This can reduce the mutual influence between adjacent electron emitting portions. Furthermore, as will be described below, with the side surface having the plurality of protrusions provided on the insulating member 3, the material of the cathode 6 is deposited on the side surface of the insulating member 3 by directional sputtering or the like, so that much more material can be deposited on the protrusions of the side surface of the insulating member 3. As a result, a controlled film-thickness distribution can be achieved on the cathode 6 on the side surface of the insulating member 3, and as shown in FIG. 7B, high-resistance portions 6b and low-resistance portions 6a can be alternately formed in the cathode 6 on the side surface of the insulating member 3. Thus, resistors (high-resistance portions 6b) can be provided between two adjacent protrusions 16 of the cathode 6, which can reduce the mutual influence between the protrusions 16 serving as electron emitting portions, thereby maintaining stable electron emission characteristics.

In FIGS. 1B and 1C, the side surface of the insulating member 3 (the side surface 3f of the first insulating layer 3a) is substantially perpendicular to the surface of the substrate 1. However, the side surface of the insulating member 3 can be a slope having an inclination smaller than 90° (for example, between 45° and 80°) to the surface of the substrate 1.

Next, the cathode 6 will be described.

The side surface 3f of the insulating member 3 has the cathode 6. In this example, the end of the cathode 6 opposite to the end adjacent to the gate 5 is electrically connected to a cathode electrode 2. However, if the cathode 6 has sufficiently low resistance, the cathode electrode 2 may be omitted. At least part of the cathode 6, located on the side surface 3f of the insulating member 3, may have resistors having a predetermined resistance for limiting current. In this case, the resistors are provided between the cathode electrode 2 and the individual protrusions 16.

The cathode 6 extends from part of the upper surface of the insulating member 3 to the side surface 3f of the insulating member 3. In the configuration shown in FIG. 1B, the cathode 6 further extends to the surface of the substrate 1.

The cathode 6 includes the plurality of protrusions 16 provided along the corner 32 (see FIGS. 2 and 3B), which is the boundary between the upper surface of the insulating member 3 and the side surface 3f of the insulating member 3. The protrusions 16 have the shape of protrusion in the Z-X plane, as in FIG. 1B, and also have the shape of protrusion in the Z-Y plane, as shown in FIG. 1D. The individual plurality of protrusions 16 protrude from the corner 32 of the insulating member 3 so as to be away from the upper surface of the insulating member 3. In an electron-beam emitting unit, described below with reference to FIG. 3A, the individual plurality of protrusions 16 protrude from the corner 32 of the insulating member 3 toward the anode 11, described below. In other words, the individual protrusions 16 protrude in the direction in which the insulating member 3 is stacked on the substrate 1, or in the direction perpendicular to the surface of the substrate 1.

In the case where the cathode 6 has the protrusions 16, the distance between the peripheral portions of the protrusions 16 and the gate 5 is wider than the distance between the protrusions 16 and the gate 5. As a result, although electrons emitted from the protrusions 16 are isotropically scattered at the gate 5, as will be described below, among the scattered electrons, electrons scattered to both side of the protrusions 16 can arrive at the anode 11 through the wide interval between the protrusions 16 and the gate 5. This can therefore enhance the electron emission efficiency η as compared with a case in which the cathode 6 is flat along the corner 32, that is, the interval between the gate and the cathode along the corner 32 is constant.

As shown in FIGS. 1B and 3B, the end of the cathode 6 adjacent to the gate 5 covers at least part of the upper surface 3e of the insulating member 3 adjacent to the side surface 3f. The plurality of protrusions 16 that constitute the end of the cathode 6 are arranged along the corner 32 (see FIGS. 2 and 3B) that is the boundary between the upper surface of the insulating member 3 (3e) and the side surface 3f of the insulating member 3. In other words, the individual protrusions 16 of the cathode 6 covers part of the upper surface 3e of the insulating member 3 adjacent to the side surface 3f. In other words, part of the protrusions 16 of the cathode 6 is fitted in the depressions 7 of the insulating member 3, and part of the protrusions 16 connects to the upper surface of the insulating member 3.

An enlarged view of the end of each protrusion 16 is shown in FIG. 3B. The end has a shape represented by a radius of curvature r. The field intensity at the end varies depending on the radius of curvature r. The smaller the radius of curvature r, the more electric flux lines concentrate, which allows high electric fields to be formed at the ends of the protrusions 16. Since the shortest distance d1 between the gate 5 and the cathode 6 influences differences in the number of times of scattering, to be described below, the smaller the radius of curvature r is and the larger the distance d1 is, the higher the electron emission efficiency η becomes. If the distance d1 is larger than 10 nm, the driving voltage is increased. However, the distance d1 is preferably 10 nm or less from the viewpoint of reducing driving voltage necessary for emitting electrons. Furthermore, d1 is preferably 1 nm or more from the viewpoint of stability of driving. This is because if d1 is smaller than 1 nm, the protrusions 16 of the cathode 6 may be broken during driving due to field evaporation, discharge, or short-circuit. Therefore, preferably, the distance d1 is practically 1 nm or more but not more than 10 nm.

The protrusions 16 cover part of the upper surface 3e of the insulating member 3, as described above. In other words, the cathode 6 is provided from the side surface 3f of the insulating member 3 to part of the upper surface 3e of the insulating member 3. Such a configuration depends on the method for forming the cathode 6, in which for EB evaporation or the like, not only the angle and time of evaporation but also the thicknesses of the gate 5 and a portion corresponding to the second insulating layer 3b serve as parameters. Furthermore, it is difficult for general sputtering to control the shape because of much wraparound. Therefore, it is necessary to employ a special method, such as directional sputtering.

The covering of part of the upper surface of the insulating member 3 with the protrusions 16 may offer the following four merits: a first merit is that mechanical adhesion is increased (adhesion strength is increased) because the protrusions 16 serving as electron emitting portions are in contact with the wide area of the insulating member 3; a second merit is that the area of thermal contact between the protrusions 16 serving as electron emitting portions and the insulating member 3 is increased to allow heat generated at the electron emitting portions to be efficiently released to the insulating layer 3 (to reduce heat resistance); a third merit is that the field strength at the triple junction at the boundary of the insulating member, vacuum, and metal can be decreased, thereby reducing the possibility of generating an abnormal electric field due to a discharge phenomenon because the protrusions 16 are in contact, with a gentle slope, with the upper surface of the insulating member 3; and a fourth merit is that the electron emission efficiency η is increased because the surface of the protrusions 16 adjacent to the second insulating layer 3b is inclined relative to the normal of the back surface 5d of the gate 5.

Here, the merit of the protrusions 16 covering not only the side surface 3f of the insulating member 3 but also part of the upper surface of the insulating member 3 will be described in more detail.

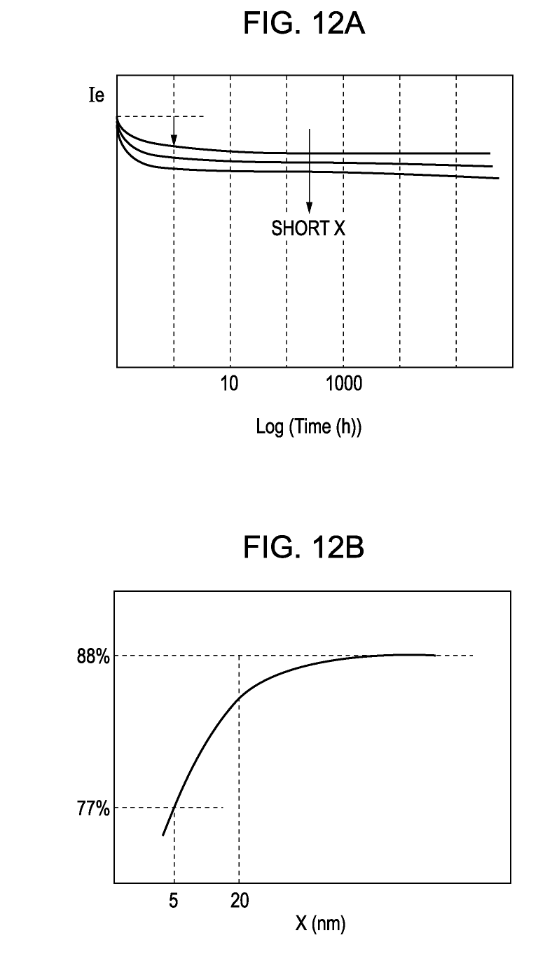

FIG. 12A shows initial Ie and its variations with time when the length x of the end (protrusion 16) of the cathode 6 adjacent to the gate 5 entering from the side surface 3f of the insulating member 3 into the depression 7 of the insulating member 3 is varied. The length x corresponds to x in FIG. 3B, which can be regarded as the length of the protrusion 16 connecting to the upper surface of the insulating member 3. Reference sign Ie denotes the amount of electrons emitted, which corresponds to the amount of electrons that reaches the anode 11 in FIG. 3A, to be described below. The average amount Ie of emitted electrons detected during the first ten seconds after the driving of the electron-emitting device is started is standardized as the initial value, and changes in the amount of electrons emitted are plotted as common logarithms versus time.

There is an apparent tendency to increase in the initial decrease in the amount of emitted electrons as the value x decreases.

FIG. 12B is a plot of the amount of emitted electrons after a lapse of one hour from the same measurement as in FIG. 12A performed on several electron-emitting devices, in which the value x is standardized with the initial amount of emitted electrons as 100. As evident from this graph, the smaller the value x, the larger the initial decrease in amount. However, when the value x exceeds 20 nm, there is a tendency to decrease the dependency on the value x.

Those results shows that the heat resistance is probably decreased since the protrusions 16 are in contact with the large area of insulating member 3 due to an increase in the value x. Furthermore, initial changes are probably decreased due to a decrease in temperature at the ends of the protrusions 16 because of an increase in heat capacity due to an increase in the volume of the protrusions 16.

A larger value x is not necessarily be desirable. The value x is practically set more than or equal to 10 nm but not more than 30 nm. The value x can be controlled by controlling the angle of evaporation of the material of the cathode 6, the thickness of the second insulating layer 3b, and the thickness of the gate 5. Setting the value x larger than 30 nm causes leakage between the cathode 6 and the gate 5 via the upper surface of the insulating member 3, thus increasing leakage-current.

Preferably, the ends of the protrusions 16 of the cathode 6 are separated from the gate 5 (the distance d1 is increased) as much as possible. This can reduce the scattering of electrons at the gate 5, thereby enhancing the electron emission efficiency η.

As shown in FIG. 3B, it is preferable to have a shift Dx between the ends of the protrusions 16 of the cathode 6 and the side surface 5a of the gate 5. In other words, it is preferable to dispose the gate 5 so that the side surface 5a of the gate 5 is located closer to the second insulating layer 3b than the protrusions (particularly, the ends) of the cathode 6. This is for enhancing the electron emission efficiency η and stabilizing emission of electrons. Since the gate 5 is not present directly above the ends of the protrusions 16, the possibility that electrons that are field-emitted from the ends of the protrusions 16 collide with the back surface 5b of the gate 5 can be reduced. This can enhance the electron emission efficiency η and also reduce ineffective current flowing to the gate 5 to prevent the thermal deformation of the gate 5, thus allowing stable electron emission to be achieved.

Next, the triple junction will be described. In general, a portion at which three kinds of material, such as vacuum, insulator, and metal, are in contact is called a triple junction, at which field strength is extremely higher than the surroundings to sometimes cause discharge or the like. Therefore, if an angle θ at which the protrusions 16 and the upper surface of the insulating member 3 are in contact is larger than 90°, its electric field does not significantly differ from a surrounding electric field. However, for example, if the cathode 6 comes off the upper surface of the insulating member 3 due to insufficient mechanical strength to form a gap between the upper surface of the insulating member 3 and the cathode 6, the angle θ becomes 90° or less. As a result, a strong electric field is formed at the portion where the cathode 6 comes off, from which electrons may be sometimes omitted, or the electron-emitting device may be sometimes broken due to creeping discharge triggered by this electron emission. Accordingly, a desire angle θ at which the protrusions 16 of the cathode 6 and the upper surface of the insulating member 3 are in contact is larger than 90°.

To stabilize electron emission characteristics, particularly, to stabilize an emission current, it is preferable to reduce the mutual influence of the plurality of protrusions 16 of the cathode 6. Thus, it is preferable that the portions 6b of the cathode 6, located between the plurality of protrusions 16, have higher resistance along the flow of electrons from the cathode electrode 2 to the protrusions 16 than the other portions 6a, as shown in FIG. 7B. More specifically, it is preferable that the resistance between two adjacent protrusions 16 of the plurality of protrusions 16 be higher than the resistance between the individual protrusions 16 and the cathode electrode 2. This can reduce the mutual influence of the plurality of protrusions 16 of the cathode 6.

In addition to the above configuration, it is more preferable to have resistors at all or part of the portions 6a in FIG. 7B. This allows the individual electron emitting portions (protrusions 16) to have resistors, so that temporal changes in emission current from the individual electron emitting portions can be advantageously reduced. Also in this configuration, the resistance between two adjacent protrusions of the plurality of protrusions 16 is set higher than the resistance between the individual protrusions 16 and the cathode electrode 2.

If the side surface of the insulating layer 3 is flat, the portions 6a in FIG. 7B are preferably thicker than the portions 6b. This can increase the creepage distance between the plurality of protrusions 16 serving as electron emitting portions as compared with a case in which the thickness of the portions 6a and the thickness of the portions 6b are equal. Furthermore, since the portions 6a can be higher in resistance than the portions 6a, the mutual influence of the protrusions 16 can be reduced, as described above.

In the electron-emitting device of this embodiment, the cathode 6 has the portions 6b in addition to the absolutely necessary portions 6a, shown in FIG. 7B, for connecting the individual plurality of protrusions 16 and the cathode electrode 2 together. The portions 6b serve to prevent part of the side surface 3f of the insulating member 3, located between the plurality of protrusions 16, from being exposed to vacuum and being charged. If the cathode 6 has not the portions 6b, part of electrons emitted from the protrusions 16 and is isotropically scattered at the gate 5 charges part of the side surface 3f of the insulating member 3, located between the protrusions 16. As a result, emission of electrons becomes unstable or the loci of emitted electrons change with time. Therefore, the cathode 6 has portions 6b located on the surface of the insulating member 3b located between the plurality of protrusions 16 in addition to the absolutely necessary portions 6a, shown in FIG. 7B, for connecting the individual plurality of protrusions 16 to the cathode electrode 2. As shown in FIGS. 1C and 2, the electron-emitting device of this embodiment is configured such that part of the cathode 6 covers not only the side surface 3f of the insulating member 3b but also part of the corner 32 of the insulating member 3, located between two adjacent protrusions 16. By disposing part of the cathode 6 between the plurality of protrusions 16 in such a manner, the surface of the insulating member 3 between the plurality of protrusions 16 is prevented from being charged, thus stabilizing emission of electrons.

Merely providing high resistance not only to the portions 6b in FIG. 7B but also to the cathode 6 including the protrusions 16 in FIG. 7A contributes to stabilization of emission current. For that purpose, the process of providing high resistance to the cathode 6 (for example, the process of oxidizing the cathode 6) should be performed.

Next, the gate 5 will be described.

The gate 5 connects to a portion, not covered with the cathode 6, of the upper surface of the insulating member 3 and is supported by the insulating member 3. The gate 5 includes a base 50 and the plurality of protrusions 15 protruding from the base 50 so as to come close to the cathode 6 (particularly, to the protrusions 16 of the cathode 6). Preferably, one protrusion 16 of the cathode 6 is provided to one protrusion 15 of the gate 5 (the protrusions 15 of the gate 5 and the protrusions 16 of the cathode 6 are provided in one-to-one correspondence. In that case, if the number of the protrusions 15 of the gate 5 is n, the number of the protrusions 16 of the cathode 6 is n.

The individual protrusions 15 protrude substantially in the same direction from the base 50. If the surface of the substrate 1 is flat, the protrusions 15 of the gate 5 generally protrude (substantially) parallel to the surface of the substrate 1. The protruding direction of the protrusions 15 of the gate 5 and the protruding direction of the protrusions 16 of the cathode 6 cross each other. In other words, in FIG. 1B, the protruding direction of the protrusions 15 of the gate 5 and the protruding direction of the protrusions 16 of the cathode 6 intersect at right angles (intersect at 90°). Preferably, the protruding direction of the protrusions 15 of the gate 5 and the protruding direction of the protrusions 16 of the cathode 6 intersect at 90° or less).

The base 50 and the protrusions 15 are employed for ease of understanding; the present invention may employ a configuration in which the base 50 and the protrusions 15 are formed of one member, that is, there is no distinct boundary between the base 50 and the protrusions 15.

The base 50 connects to part of the upper surface of the insulating member 3 (is placed on the upper surface of the insulating member 3). In the case where the insulating member 3 is constituted of the first insulating layer 3a and the second insulating layer 3b, as shown in FIG. 1, the base 50 connects to the upper surface 3c of the second insulating layer 3b. As a result, the gate 5 is supported by the second insulating layer 3b. As shown in FIGS. 1B and 1C, the base 50 may be configured such that part of the bottom does not connect to the upper surface of the insulating member 3. In other words, there may be a gap between part of the base 50 (the end adjacent to the cathode 6) and the upper surface of the insulating member 3. In contrast, the entire bottom of the base 50 may connect to part of the upper surface of the insulating member 3.

The individual protrusions 15 of the gate 5 protrude from the base 50 so that at least the ends thereof and the cathode 6 form the gap 8 therebetween. Accordingly, the gate 5 is shaped like comb teeth in plan view (in a plane parallel to the surface of the substrate 1), as shown in FIG. 1A. Although FIG. 3B shows an example in which the angle of the side surface 5a of the gate 5 with respect to the bottom surface 5b of the gate 5 is 90°, it is preferable that angle be set at less than 90° to enhance the electron emission efficiency η. The shortest distance of the gap 8 corresponds to the shortest distance d1, described above. Here, the outer periphery (side surface 5a) of the protrusions 15 of the gate 5 is like a rectangular wave in which straight lines connect to each other at right angles when the electron-emitting device is viewed from the top (viewed from the direction of FIG. 1A). However, the configuration of the electron-emitting device of this embodiment is not limited thereto. For example, it is possible to have either an outer periphery (side surface 5a) in which arcs continue like a sine wave or an outer periphery (side surface 5a) in which straight lines are connected together at an acute angle like a triangle wave. It is also possible that the side surface 5a of the protrusions 15 has an arc shape (having a curvature), and portions between the protrusions 15 have a linear shape. In view of registration with the protrusions 16 of the cathode 6, it is preferable that at least the side surface 5a of the protrusions 15 of the gate 5 (particularly, the side surface 5a at the ends of the protrusions 15 farthest from the base 50) have an arc shape (having a curvature).

Next, the operation of the protrusions 15 of the gate 5 will be described.

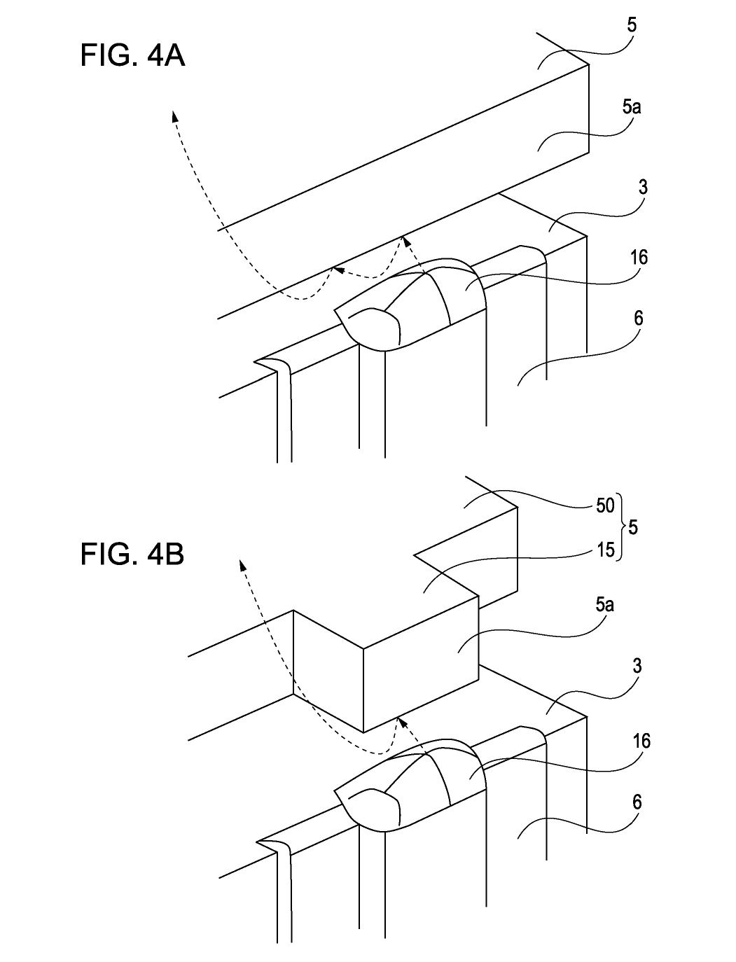

FIG. 4A shows a configuration in which the gate 5 has not the protrusions 15 (the side surface 5a of the gate 5 is flat); and FIG. 4B shows a configuration in which the gate 5 has the protrusions 15 (the side surface 5a of the gate 5 has depressions and protrusions). The drawings schematically show only part of the electron-emitting device for ease of explanation.

As shown in FIG. 4A, in the case where the gate 5 has not the protrusions 15 and the gate 5 is wider than the cathode 6 in the area where the gate 5 and the cathode 6 oppose, electrons emitted from the protrusions 16 of the cathode 6 are scattered. Specifically, as indicated by the broken lines in the drawings, electrons emitted from the protrusions 16 of the cathode 6 are isotropically scattered on the bottom surface 5b or the side surface 5a of the gate 5. Part of the scattered electrons collides with the gate 5 again to repeat scattering.

On the other hand, as shown in FIG. 4B, by providing the protrusions 15 at the area of the gate 5 opposing the protrusions 16 of the cathode 6 (by backspacing both sides of the area of the gate 5 opposing the protrusions 16 of the cathode 6), collision of electrons against the gate 5 can be reduced as compared with the configuration of FIG. 4A. This can reduce scattering of electrons on the gate 5. The configuration of FIG. 4B can therefore increase electrons that reach the anode 11, thus enhancing the efficiency η.

Next, a method for evaluating the electron emission characteristics of the electron-emitting device and the efficiency of arrival of electrons emitted from the cathode 6 to the anode 11, that is, the electron emission efficiency η), will be described. The electron emission efficiency η is given by η=Ie/(If+Ie) where If is a current detected when voltage is applied to the electron-emitting device and Ie is a current taken in vacuum (a current that reaches the anode 11).

The electron emission characteristics of the electron-emitting device can be measured using the configuration shown in FIG. 3A. In FIG. 3A, Vf is a voltage applied between the gate 5 and the cathode 6; If is a device current flowing between the gate 5 and the cathode 6 when the voltage Vf is applied between the gate 5 and the cathode 6; Va is a voltage applied between the cathode 6 and the anode 11; and Ie is an electron emission current. Although FIG. 3A shows an example in which the voltage Va is applied between the cathode 6 and the anode 11, a power source that applies potential to the anode 11 and a power source that applies potential to the cathode 6 may be separately provided. As shown in FIG. 3A, the anode 11 that is set at higher potential than the gate 5 and cathode 6 is provided above the substrate 1 having the electron-emitting device to thereby configure an electron-beam emitting unit in which electrons emitted from the plurality of protrusions 16 brought to the anode 11.

Next, the relationship between the electron emission efficiency η and the sizes of the components of the electron-emitting device will be described using simulated calculations. As shown in FIG. 2, the amplitude of the protrusions 15 of the gate 5 (the distance from the base 50 to the ends of the protrusions 15 (the length in the X-direction)) is defined as A1, the period of the protrusions 15 of the gate 5 (the length in the Y-direction) is defined as T1, the interval between the protrusions 15 of the gate 5 is defined as W2, and the width of the protrusions 15 of the gate 5 is defined as W1.

Typical examples of the values in calculations below are as follows: the thickness of the insulating layer 3a is 10 nm; the thickness of the insulating layer 3b is 200 nm; the thickness of the gate 5 is 5 nm; the distance d1 between the gate 5 and the cathode 6 is 5 nm; the amplitude A1 of the gate 5 is 6 nm; the period T1 is 12 nm; the driving voltage Vf is 21 V; the anode applied voltage Va is 11.8 kV; and the work function Wf of the cathode 6 is 4.6 eV.

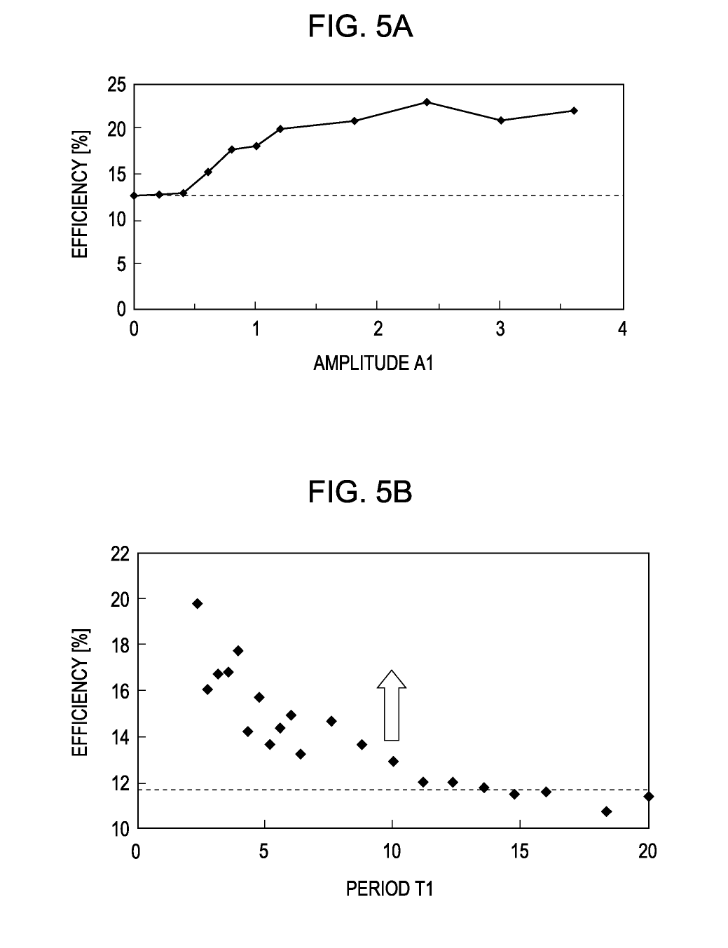

First, the relationship between the amplitude A1 of the protrusions 15 of the gate 5 and the efficiency η will be described using FIG. 5A. The horizontal axis in FIG. 5A shows values of the amplitude A1 of the protrusions 15 of the gate 5 standardized by the shortest distance d1 between the protrusions 16 of the cathode 6 and the gate 5, and the vertical axis shows the electron emission efficiency η. FIG. 5A shows that when the amplitude A1 of the protrusions 15 of the gate 5 is increased, the electron emission efficiency η increases significantly at a certain amplitude or more and is thereafter held substantially constant. Letting Alsta be an amplitude at which the electron emission efficiency η begins to increase, Alsta is read to be 0.5×d1. The tendency shown in FIG. 5A does not significantly change depending on the thicknesses, widths, depths, and materials of the components of the electron-emitting device. Accordingly, it is preferable that the amplitude A1 of the protrusions 15 of the gate 5 be set at 0.5×d1 or more in consideration of the shortest distance d1 between the protrusions 16 of the cathode 6 and the gate 5. The calculation is made, with the centers of the protrusions 16 of the cathode 6 and the centers of the protrusions 15 of the gate 5 agreed with each other in the vertical direction.

The reason that the electron emission efficiency η is significantly increased when the amplitude A1 exceeds Alsta seems to be because electrons emitted from the electron emitting portions (more specifically, electrons scattered at the gate 5) pass between two adjacent protrusions 15 of the gate 5 to easily reach the anode 11. In contrast, the reason that the electron emission efficiency η is substantially constant when the amplitude A1 is smaller than A1sta seems to be because there is little difference from the case in which the gate 5 has not the protrusions 15. The reason that the electron emission efficiency η is saturated is because the amplitude A1 of the protrusions 15 of the gate 5 becomes sufficiently large, so that there is no difference in the amount of emitted electrons passing between two adjacent protrusions 15 of the gate 5.

Next, the relationship between the period T1 of the protrusions 15 of the gate 5 and the electron emission efficiency η will be described using FIG. 5B. The horizontal axis in FIG. 5B shows values of the period T1 of the protrusions 15 of the gate 5 standardized by the shortest distance d1 between the protrusions 16 of the cathode 6 and the gate 5, and the vertical axis shows the electron emission efficiency η. FIG. 5B shows that when the period T1 of the protrusions 15 of the gate 5 is increased, the electron emission efficiency η decreases significantly and is held substantially constant at a certain period or more. Letting T1sat be a period at which the electron emission efficiency η becomes substantially constant, T1sat is read to be 10×d1. The tendency shown in FIG. 5B does not significantly change depending on the thicknesses, widths, depths, and materials of the components of the electron-emitting device. Accordingly, it is preferable that the period T1 of the gate 5 be set at 10×d1 or less.

T1 is the sum of W1 and W2 in FIG. 2. In the calculation in FIG. 5B, W1=W2 is assumed, and the centers of the protrusions 16 of the cathode 6 and the centers of the protrusions 15 of the gate 5 agree with each other in the vertical direction. Accordingly, an increase in the period T1 of the protrusions 15 of the gate 5 means that W1 and W2 increase. Therefore, the reason that the electron emission efficiency η is decreased when the period T1 of the protrusions 15 of the gate 5 increases seems to be because the width W1 of the protrusions 15 of the gate 5 that overhang the protrusions 16 of the cathode 6 increases. In other words, it seems to be because the width W1 of the protrusions 15 of the gate 5 located directly above the protrusions 16 increases. The reason that the electron emission efficiency η becomes substantially constant when the T1 exceeds T1sat seems to be because there is little difference from the case in which the gate 5 does not have the protrusions 15.

Next, a modification of the electron-emitting device, in which the relative positional relationship between the protrusions 15 of the gate 5 and the protrusions 16 of the cathode 6 is different from the electron-emitting device, as shown in FIG. 2, will be described using FIG. 8.

The electron-emitting device of the modification is configured such that each of the protrusions 16 of the cathode 6 faces a portion between two adjacent protrusions 15 of the gate 5. Typically, the phases of the protrusions 15 of the gate 5 and the protrusions 16 of the cathode 6 are shifted by half period from the configuration described in FIG. 2 etc. Although FIG. 8 shows only one of the protrusions 16 of the cathode 6 for ease of explanation, a plurality of protrusions 16 is actually provided along the corner 32. Likewise, only two of the protrusions 15 of the gate 5 are shown, a plurality of (≧2) protrusions 15 of the gate 5 are actually provided. That is, one protrusion 16 of the cathode 6 is provided for two protrusions 15 of the gate 5. Therefore, the number of the protrusions 16 of the cathode 6 is n-1 at the minimum, where n is the number of the protrusions 15 of the gate 5.

In the electron-emitting device of the modification, each protrusion 16 of the cathode 6 is opposed to a portion between two adjacent protrusions 15 of the gate 5. Therefore, electric flux lines immediately above the protrusions 16 do not directly proceed to the gate 5, and a direction in which electrons are emitted from the protrusions 16 are nearly vertical to the surface of the substrate 1. Accordingly, as shown in FIG. 8, the amount of electrons emitted toward an anode (not shown) without colliding with the gate 5 are larger than that of the electron-emitting device of the embodiment, shown in FIG. 2 etc. The electron emission efficiency η is therefore enhanced as compared with the electron-emitting device of the embodiment, shown in FIG. 2 etc. Since the amount of electrons scattered at the gate 5 is smaller than the electron-emitting device of the embodiment, shown in FIG. 2 etc., the area (spot diameter) of the anode irradiated with electrons emitted from the electron-emitting device can be decreased.

Next, the electron emission efficiency η of this modification will be described.

First, the relationship between the amplitude A1 of the protrusions 15 of the gate 5 and the electron emission efficiency η will be described.

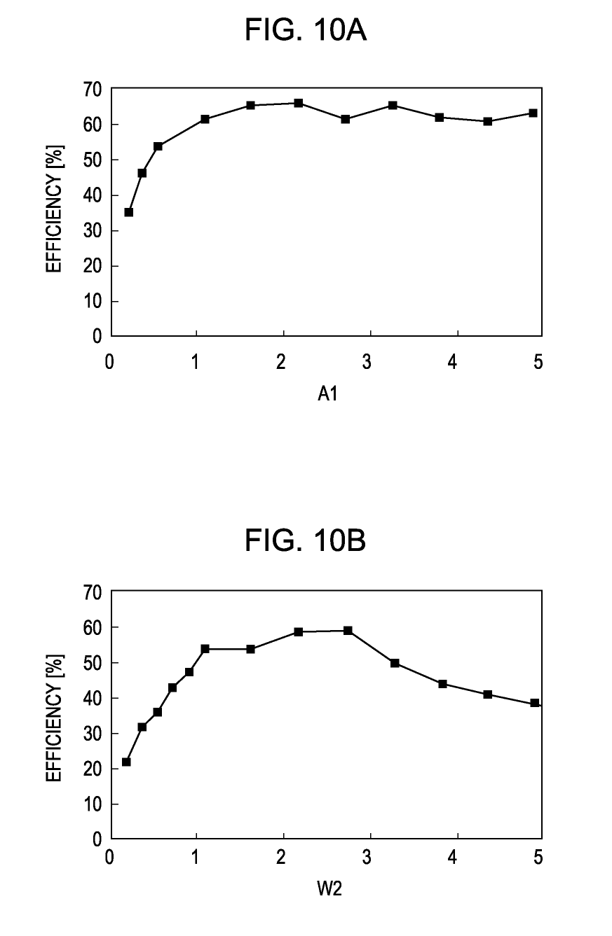

FIG. 10A shows the relationship between the amplitude A1 of the protrusions 15 of the gate 5 and the efficiency η. The horizontal axis in FIG. 10A shows values of the amplitude A1 standardized by the shortest distance d1 between the protrusions 16 of the cathode 6 and the gate 5, and the vertical axis shows the efficiency η.

FIG. 10A shows that when the amplitude A1 is increased, the efficiency η also increases, and the increase in the efficiency η slows at a certain value or more to be substantially saturated. Letting A1sat be an amplitude at which the increase in efficiency η begins to slow, A1sat is read to be about 1×d1. The tendency shown in FIG. 10A does not significantly change depending on the thicknesses, widths, depths, and materials of the components of the electron-emitting device. The reason that the efficiency η increases as the amplitude A1 is increased seems to be because the area of the gate 5 that overhangs the protrusions 16 of the cathode 6 decreases (the gate 5 is separated from directly above the protrusions 16). This may make it easy for electrons emitted from the protrusions 16 to pass between two adjacent protrusions 15 of the gate 5, thus enhancing the efficiency η. The reason when the increase in efficiency η slows at A1sat or more may be that the amplitude A1 is large enough, so that the number of electrons that do not strike the gate 5 becomes substantially constant.

Therefore, it is preferable for the electron-emitting device of the modification that the amplitude A1 of the protrusions 15 of the gate 5 and the shortest distance d1 between the protrusions 16 of the cathode 6 and the gate 5 satisfies the relationship A1≧d1. This can reduce the collision of electrons emitted from the protrusions 16 of the cathode 6 against the gate 5, thus enhancing the efficiency η.

Next, the relationship between the interval W2 between two adjacent protrusions 15 of the gate 5 and the efficiency η will be described.

FIG. 10B shows the relationship between the interval W2 between two adjacent protrusions 15 of the gate 5 and the efficiency η. The horizontal axis in FIG. 10B shows values of the interval W2 standardized by the shortest distance d1 between the cathode 6 and the gate 5, and the vertical axis shows the electron emission efficiency η. FIG. 10B shows that when the interval W2 is increased, the efficiency η increases, and the efficiency η becomes substantially constant at a certain value or more, and when the interval W2 is further increased, the efficiency η begins to decrease. Letting W2sat be a value at which the efficiency η begins to be saturated, W2sat is read to be about 1×d1. Letting W2dec be a value at which the efficiency η begins to decrease, W2dec is read to be 3×d1. The tendency shown in FIG. 5A does not significantly change depending on the thicknesses, widths, depths, and materials of the components of the electron-emitting device. The reason that the efficiency η increases as the interval W2 is increased to W2sat seems to be because the width of the gate 5 that overhangs the protrusions 16 of the cathode 6 decreases. The reason that the efficiency η is substantially constant from the interval W2=W2sat to W2dec seems to be because the number of electrons that do not collide with the gate 5 is substantially constant. The reason that the efficiency η is decreased when the interval W2 becomes larger than W2dec may be because this configuration does not differ from a configuration in which the gate 5 has not the protrusions 15.

Therefore, it is preferable for the electron-emitting device of the modification that the interval W2 between two adjacent protrusions 15 of the gate 5 and the shortest distance d1 between the protrusions 16 of the cathode 6 and the gate 5 satisfy the relationship, d1≦W2≦3×d1.

In the electron-emitting device of the modification, collision of electrons emitted from the protrusions 16 of the cathode 6 against the gate 5 can be reduced, thus enhancing the efficiency η.

The electron-emitting device of the present invention may have the relative positional relationship between the protrusions 15 of the gate 5 and the protrusions 16 of the cathode 6, shown in FIG. 8, in addition to the relative positional relationship between the protrusions 15 of the gate 5 and the protrusions 16 of the cathode 6, shown in FIG. 2 etc.

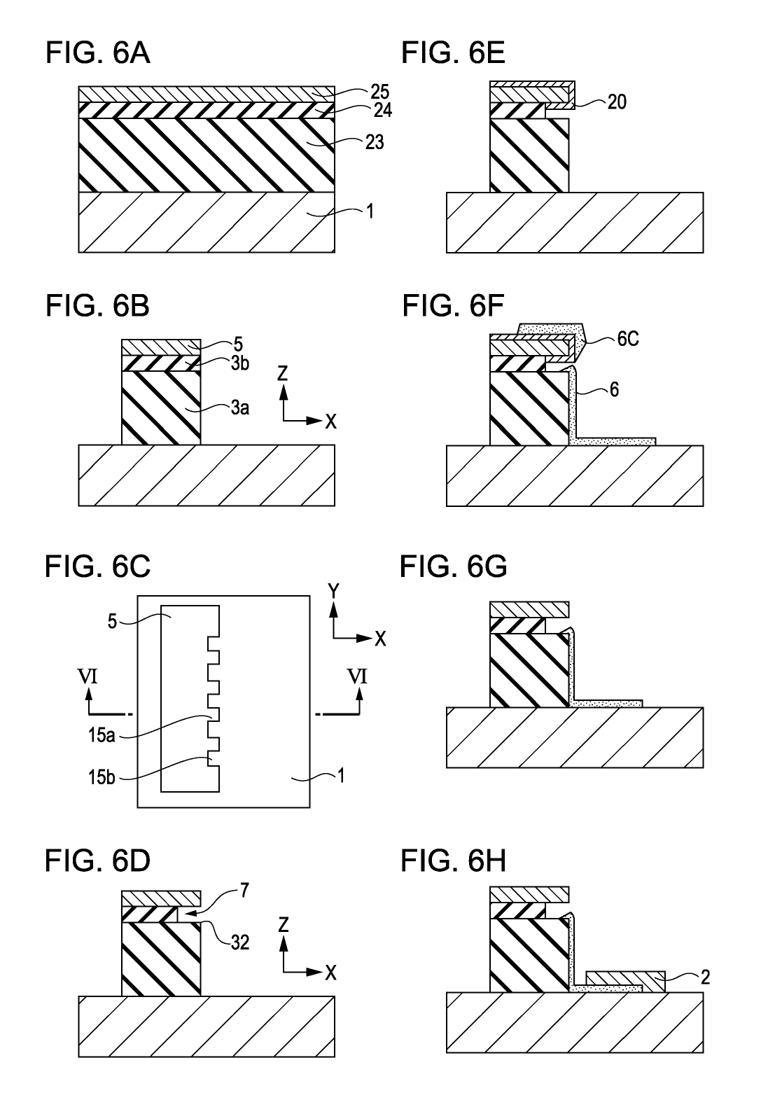

An example of the method for manufacturing the electron-emitting device of this embodiment, described above, will be described with reference to FIGS. 6A to 6H. A method for manufacturing the electron-emitting device of the modification, described using FIG. 8, will be described later.

FIGS. 6A to 6H are schematic diagrams illustrating an example of the process of manufacturing the electron-emitting device shown in FIG. 1A to 1D in sequence.

First, an insulating layer 23 serving as the first insulating layer 3a, an insulating layer 24 serving as the second insulating layer 3b, and a conductive layer 25 serving as the gate 5 are stacked on the surface of the substrate 1 (FIG. 6A).

The substrate 1 is an insulative substrate made of, for example, quartz glass, glass in which impurities, such as sodium, are reduced, soda-lime glass, and silicon. The insulating layers 23 and 24 are insulative films made of a material with high processability, such as, SiN(SiₓN_{y}) and SiO₂. The insulating layers 23 and 24 are manufactured by a general vacuum film forming method, such as a sputtering method, a CDV method, or a vapor deposition method. The thicknesses of the insulating layers 23 and 24 are set in the range between 5 nm and 50 μm, preferably, between 50 nm and 500 nm. Since the depressions 7 need to be formed after the insulating layers 23 and 24 are stacked on the substrate 1, the insulating layer 23 and the insulating layer 24 need to have different etching rate from each other. Preferably, a selection ratio of the insulating layer 23 to the insulating layer 24 is 10 or more, and 50 or more if possible. Specifically, for example, the insulating layer 23 can employ an insulating material, such as SiₓN_{y}, and the insulating layer 24 can employ an insulating material, such as SiO₂, a PSG film having a high phosphorous concentration, or a BSG film having a high boron concentration.

The conductive layer 25 is formed by a general vacuum film forming technology, such as a vapor deposition method and a sputtering method. A material for the conductive layer 25 is preferably a material having high conductivity, high thermal conductivity, and high melting point, for example, metals, such as Be, Mg, Ti, Zr, Hf, V, Nb, Ta, Mo, W, Al, Cu, Ni, Cr, Au, Pt, and Pd, alloys thereof, and carbides, such as TiC, ZrC, HfC, TaC, SiC, and WC. Examples of the material also include borides, such as HfB₂, ZrB₂, CeB₆, YB₄, and GdB₄, and nitrides, such as TiN, ZrN, HfN, and TaN. The thickness of the conductive layer 25 is set in the range between 5 nm and 500 nm.

Next, after a resist pattern is formed on the conductive layer 25 by a photolithography technology, the conductive layer 25, the insulating layer 24, and the insulating layer 23 are processed in sequence with an etching technique. Thus, the gate 5 and the insulating member 3 formed of the insulating layer 3b and the insulating layer 3a can be obtained (FIG. 6B).

For such an etching process, reactive ion etching (RIE) is generally used which can precisely etch the materials by irradiating the materials with a plasma of etching gas. Examples of the processing gas to be used at this time include fluorine-based gases, such as CF₄, CHF₃, and SF₆, when the target member forms fluoride. When the target member forms chloride, such as Si and Al, chloride-based gases, such as Cl₂ and BCl₃, are selected. To obtain the selection ratio to the resist, to ensure the smoothness of the etched surface, or to increase the etching speed, hydrogen, oxygen, argon gas, or the like is added when necessary.

Next, protrusions are formed on the side surface of the gate 5 and the side surface of the insulating member 3 formed of the insulating layers 3a and 3b using focused ion beams (FIB) (FIG. 6C).

In the FIB processing, the side surface of the gate 5 is cut off so that the amplitude A1 and the period T1 of the protrusions 15 of the gate 5 reach desired values. The following description is made with reference to the drawings as viewed along the cross section VI-VI in FIG. 6C.

Subsequently, only the side surface of the insulating layer 3b is partly removed by etching to form the depressions 7 (FIG. 6D).

For the etching technique, for example, a mixture solution of ammonium fluoride and hydrofluoric acid, which is referred to as a buffer hydrofluoric acid (BHF), can be used if the insulating layer 3b is formed of a material made from SiO₂. If the insulating layer 3b is formed of a material made from SiₓN_{y}, the insulating layer 3b can be etched using a phosphoric-acid-based hot etching solution.

The depth of the depressions 7, that is, the distance, of the depressions 7, between the side surface of the insulating layer 3b and the side surfaces of the insulating layer 3a and the gate 5 have close connection with leakage-current after the electron-emitting device is formed. The deeper the depressions 7, the smaller the leakage-current. However, since excessively deep depressions 7 will cause problems, such as deformation of the gate 5, the depth of the depressions 7 is practically set at 30 nm or more but not more than 200 nm.

Next, a release layer 20 is formed on the surface of the gate 5 (FIG. 6E).

The release layer 20 is formed for the purpose of releasing the material of the cathode 6, which is deposited in the next process, from the gate 5. For this purpose, the release layer 20 is formed, for example, by forming an oxide film on the gate 5 through oxidation or by depositing release metal by electrolytic plating.

Next, the material of the cathode 6 is deposited on the substrate 1, the side surface of the insulating member 3, and the gate 5 (FIG. 6F).

The material of the cathode 6 should be a conductive material capable of field emission, generally having a high melting point of 2,000° C. or higher and a work function of 5 eV or less, and preferably, a material that hardly forms a chemical reaction layer, such as oxide, or from which the reaction layer can easily removed. Examples of the material include metals, such as Hf, V, Nb, Ta, Mo, W, Au, Pt, and Pd, alloys thereof, carbides, such as TiC, ZrC, HfC, TaC, SiC, and WC, and borides, such as HfB₂, ZrB₂, CeB₆, YB₄, and GdB₄.

A method for depositing the material of the cathode 6 (cathode material) is preferably a directional sputtering method. The reason why the directional sputtering method is preferable is that the plurality of protrusions 16 are formed along the corner 32 so as to cover part of the interior of the depressions 7 (part of the upper surface of the insulating member 3). With the sputtering method, the energy of the sputtered particles of the cathode material is small. Therefore, the plurality of protrusions 16 seems to be easily formed along the corner 32 of the insulating member 3 since the sputtered particles come flying to the corner 32 of the insulating member 3 through the space between two adjacent protrusions 15 of the gate 5 (space 15b in FIG. 7A), in other words, because the cathode material can easily be deposited directly below the protrusions 15 of the gate 5.

FIG. 7A is a schematic diagram illustrating a state in which the material of the cathode 6 is deposited on the side surface of the insulating member 3 from the same direction as in FIG. 1D, in which typical flying loci of the cathode material are indicated by broken lines 26a to 26d. As shown in FIG. 7A, if protrusions are formed on the side surface of the insulating layer 3a, the sputtering method affixes much more cathode material to the protrusion of the side surface of the insulating layer 3a than to the other portion of the side surface of the insulating layer 3a due to projection effect. Furthermore, as indicated by the broken lines 26a to 26c, sputtered particles (cathode material) pass through the space (15b) between two adjacent protrusions 15 of the gate 5. Therefore, the much more cathode material is deposited on the corner 32 of the insulating layer 3a in the vicinity of the joint between the upper surface of the insulating layer 3a and the protrusions on the side surface of the insulating layer 3a. As a result, the plurality of protrusions 16 are formed along the corner 32 in correspondence with the period of the protrusions 15 of the gate 5. Thus, the protrusions 15 of the gate 5 and the protrusions 16 of the cathode 6 can be provided in one-to-one correspondence. Meanwhile, the flying loci of the cathode material include a flying locus perpendicular to the surface of the substrate 1 through the space (15b) between two adjacent protrusions 15 of the gate 5, as indicated by the broken line 26d. Most of the cathode material flying along such a locus is not affixed to the surface (side surface) of the insulating member 3, depending on the degree of inclination of the side surface of the insulating member 3, but is affixed to the substrate 1. In view of such a phenomenon, by controlling the angle of sputtering, the time, temperature, and the degree of vacuum for deposition, protrusions 16 with a desired shape can be provided.

As shown in FIG. 2, the electron-emitting device is configured such that the cathode 6 covers the portion from the side surface 3f of the insulating layer 3a through the corner 32 of the insulating layer 3a to the corner-32-side upper surface 3e of the insulating layer 3a between the plurality of protrusions 16. This configuration can be achieved, for example, by providing (setting back) the side surface 5a of the gate 5 in the -X direction relative to the side surface 3f of the insulating layer 3a or by sputtering the material of the cathode 6 from diagonally above to the side surface 5a of the gate 5 and the side surface 3f of the insulating member 3. Alternatively, this configuration can also be achieved by inclining both the side surface 5a of the gate 5 and the side surface 3f of the insulating member 3 at a predetermined angle (<90°) with respect to the surface of the substrate 1.

Next, the cathode material 6C on the gate 5 is removed by removing the release layer 20 by etching (FIG. 6G). Although the cathode material 6C on the gate 5 is removed here, the cathode material 6C may be left on the gate 5.

Next, the cathode electrode 2 is formed for electrical conduction with the cathode 6 (FIG. 6H).

The cathode electrode 2 has conductivity like the cathode 6 and is formed by a general vacuum film-forming technology, such as a vapor deposition method and a sputtering method, or a photolithographic technology. Examples of the material of the electrode 2 include metals, such as Be, Mg, Ti, Zr, Hf, V, Nb, Ta, Mo, W, Al, Cu, Ni, Cr, Au, Pt, and Pd, alloys thereof, carbides, such as TiC, ZrC, HfC, TaC, SiC, and WC, borides, such as HfB₂, ZrB₂, CeB₆, YB₄, and GdB₄, and nitrides, such as TiN, ZrN, HfN. The thickness of the cathode electrode 2 is set in the range between 5 nm and 50 μm. The cathode electrode 2 and the gate 5 may be made of either the same material or different materials and may be made either by the same forming method or by different methods. The gate 5 is sometimes set thinner than the gate 5 in thickness and is preferably made of a low-resistance material.

The electron-emitting device with the configuration shown in FIGS. 1A to 1D can be formed by the process described above.

Next, a method for manufacturing the electron-emitting device of the modification described using FIG. 8 will be described. Since the basic manufacturing method is the same as that described using FIG. 6, only differences from the above description will be described here.

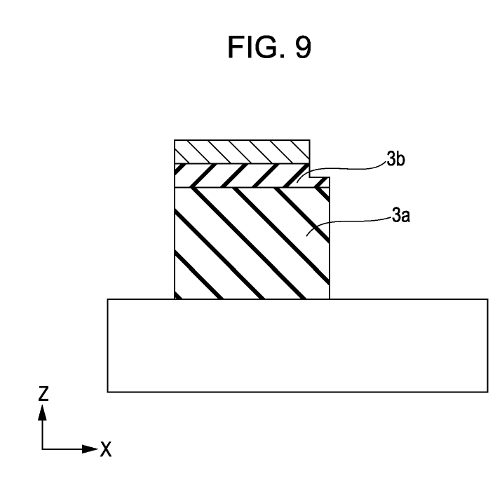

In the case of the electron-emitting device of the modification, protrusions are formed only on the gate 5 and the insulating layer 3b using FIB in the process of FIG. 6C, and are not formed on the insulating layer 3a (FIG. 9). The FIB process should be performed so that the amplitude A1 of the gate 5 and the interval W2 between the protrusions 15 of the gate 5 reach desired values. The subsequent process for manufacturing the electron-emitting device is the same as in the first embodiment. Since the side surface 3f of the insulating layer 3a is not provided with protrusions, the upper surface of the insulating layer 3a is exposed between two adjacent protrusions 15 of the gate 5 in plan view. This allows a large amount of cathode material to be locally affixed to the corner 32 of the insulating layer 3a corresponding to the portion between two adjacent protrusions 15 of the gate 5. As a result, the protrusions 16 can be formed on the corner 32 of the insulating layer 3a corresponding to the two adjacent protrusions 15 of the gate 5.

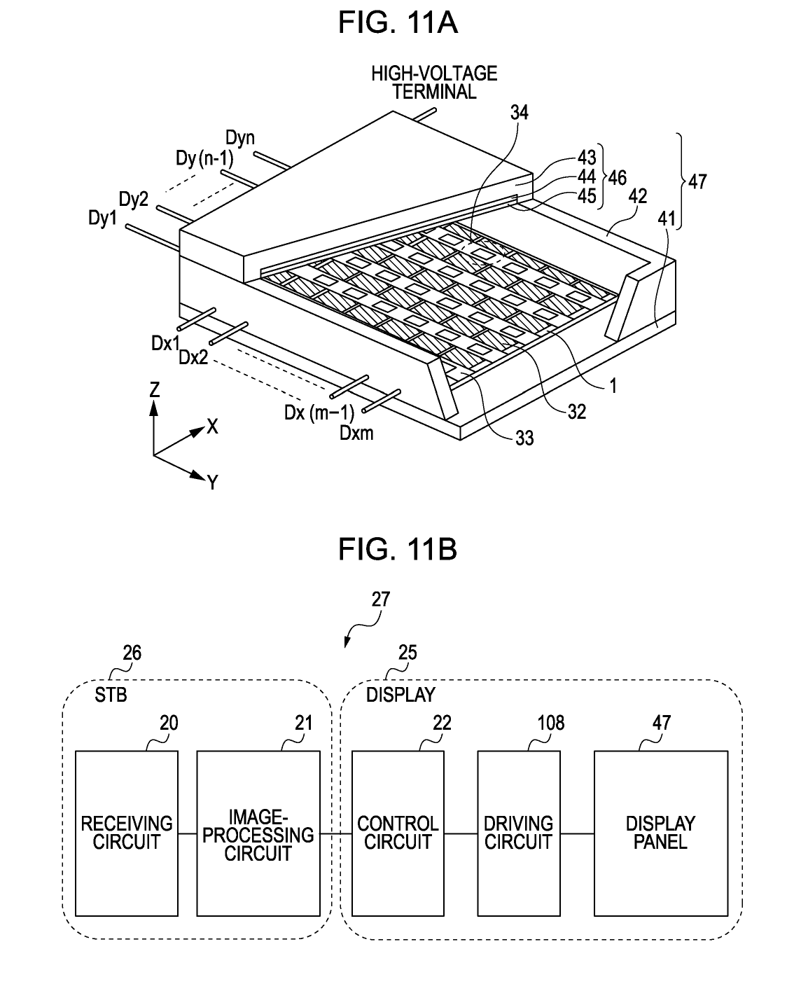

An electron source in which the plurality of electron-emitting devices described above are provided on a substrate and a display panel including the electron source will be described hereinbelow using FIGS. 11A and 11B.

FIG. 11A is a schematic diagram illustrating an example of a display panel 47 including an electron source in which the electron-emitting devices are disposed in matrix form, part of which is cut away to show the interior. In FIG. 11A, reference numeral 31 denotes an electron source substrate, numeral 32 denotes an X-direction wire, numeral 33 denotes a Y-direction wire, and the electron source substrate 31 corresponds to the substrate 1 of the electron-emitting device described above. Numeral 34 denotes the electron-emitting device described above. The X-direction wires 32 connect the electrodes 2 in common, and the Y-direction wires 33 connect the gates 5 in common. Here, an example in which the electron-emitting devices are provided at the intersections of the X-direction wires 32 and the Y-direction wires 33 is schematically shown. Alternatively, the electron-emitting devices may be provided by the side of the intersections of the X-direction wires 32 and the Y-direction wires 33 on the electron source substrate 31.

The X-direction wires 32 are connected to a scanning-signal apply unit (not shown) that applies a scanning signal for selecting a row of the electron-emitting devices 34 arrayed in the X-direction. The Y-direction wire 33 is connected to a modulation-signal generation unit (not shown) for modulating the individual columns of the electron-emitting devices 34 in response to input signals. Driving voltages applied to the individual electron-emitting devices are supplied as difference voltages between the scanning signals applied to the devices and the modulation signals.

The above configuration allows individual devices to be selected and driven independently using simple matrix wiring.

In FIG. 11A, the electron source substrate 31 is fixed to a rear plate 41. A light-emitting member 44 formed of, for example, phosphor, that emits light when irradiated with electrons emitted from the electron-emitting devices and a metal back 45 corresponding to the anode 11 described above are stacked on the inner surface of a glass substrate 43 to form a face plate 46. The rear plate 41 and the face plate 46 are hermetically joined together via a support frame 42 provided between the rear plate 41 and the face plate 46 and a joint member, such as frit glass, to form a display panel 47. The display panel 47 is constituted of the face plate 46, the support frame 42, and the rear plate 41, as described above. Since the rear plate 41 is mainly provided to reinforce the strength of the electron source substrate 31, the separate rear plate 41 can be omitted if the electron source substrate 31 itself has sufficient strength. In other words, the support frame 42 may be directly sealed on the electron source substrate 31, so that the display panel 47 is formed of the face plate 46, the support frame 42, and the electron source substrate 31. Alternatively, a support member called a spacer may be disposed between the face plate 46 and the rear plate 41 to provide sufficient strength against air pressure.

Next, a display 25 equipped with the display panel 47, described above, and a television set 27 will be described using the block diagram of FIG. 11B.

A receiving circuit 20 includes a tuner and a decoder, receives TV signals of satellite broadcasting, terrestrial broadcasting, etc. and various signals of data broadcasting via networks, and outputs decoded image data to an image-processing unit 21. The “signals” can translate into “input signals”. The image-processing unit 21 includes a γ compensating circuit, a resolution converting circuit, and an interface circuit. The image-processing unit 21 converts processed image data to the display format of the display (image display unit) 25 and outputs the image data to the display 25 as image signals.

The display 25 includes at least the above-described display panel 47 and further includes a driving circuit 108 and a control circuit 22 that controls the driving circuit 108. The control circuit 22 performs signal processing, such as a compensating process, on input image signals and outputs the image signals and various control signals to the driving circuit 108. The control circuit 22 includes a synchronizing-signal separating circuit, an RGB converting circuit, a luminance-signal converting section, and a timing control circuit. The driving circuit 108 outputs driving signals to the electron-emitting devices in the display panel 47 in response to input image signals, so that TV pictures are displayed on the basis of the driving signals. The driving circuit 108 includes a scanning circuit, a modulating circuit, and a high-voltage supply circuit that supplies anode potential. The receiving circuit 20 and the image-processing circuit 21 may be accommodated in a housing, as a set top box (STB 26), separate from the display 25, or alternatively, may be accommodated in a housing integrated with the display 25. Here, an example in which the television set 27 displays TV pictures is described. However, assuming that the receiving circuit 20 is a circuit that receives images distributed via the Internet etc., the television set 27 functions as an image display apparatus capable of displaying not only TV pictures but also various images.

### EXAMPLES

More concrete examples based on the foregoing embodiment will be described hereinbelow.

### Example 1

In this example, the electron-emitting device shown in FIGS. 1A to 1D was manufactured according to the process in FIGS. 6A to 6H.

The substrate 1 is made from PD200 that is low-sodium glass developed for plasma displays, on which the insulating layer 23 made from SiN(SiₓN_{y}) with a thickness of 500 nm was formed by sputtering. Next, the insulating layer 24 made from SiO₂ with a thickness of 25 nm was formed thereon by sputtering. Furthermore, the conductive layer 25 made from TaN with a thickness of 30 nm was stacked on the insulating layer 24 by sputtering (FIG. 6A).

Next, a resist pattern was formed on the conductive layer 25 using a photolithographic technology. Thereafter, the conductive layer 25, the insulating layer 24, and the insulating layer 23 were processed in sequence using a dry etching technique to form the gate 5 and the insulating member 3 constituted of the first insulating layer 3a and the second insulating layer 3b (FIG. 6B). Since a material that produces fluoride in the insulating layers 23 and 24 and the conductive layer 25 was selected, a CF₄-based gas was used as processing gas to be used at that time. As a result of RIE using the gas, the side surface 3f of the insulating layer 3a, the side surface 3d of the insulating layer 3b, and the side surface 5a of the gate 5 after etching formed about 80° with respect to the horizontal surface of the substrate 1.

Next, after the resist was released, protrusions are formed on the side surface of the gate 5 and the side surface of the insulating member 3 using FIB, as shown in FIG. 6C. In the FIB processing, the side surfaces were cut off so that the amplitude A1 of the protrusions 15 of the gate 5 reaches 6 nm, and the period T1 reaches 12 nm, and the width W1 of the protrusions 15 reaches 6 nm.

Next, the side surface 3d of the insulating layer 3b was etched using BHF (hydrofluoric acid/ammonium fluoride solution) into a depth of about 70 nm to form the depressions 7 in the insulating member 3 (FIG. 6D).

Next, Ni was educed on the surface of the gate 5 by electrolytic plating to form the release layer 20 (FIG. 6E).

Next, molybdenum (Mo) serving as a cathode material was deposited on the release layer 20, the side surface of the insulating member 3, and the surface of the substrate 1 to form molybdenum films (6 and 6C). A directional sputtering method was used to form the films. With this film forming method, the angle of the substrate 1 was set so that the substrate 1 is horizontal to the sputter target. This sputtering technique employed a shield plate so that sputtered particles are incident on the substrate surface at limited angles. The peaks of the incident angle were set at 90° and 60° with respect to the horizontal direction using the shield plate. Argon plasma was generated at an output of 3.0 kW and a degree of vacuum of 0.1 Pa, the substrate 1 was disposed so that the distance between the substrate 1 and the Mo target is 100 mm or less, and a molybdenum film with a thickness of 20 nm was formed on the substrate 1 (FIG. 6F).

After the molybdenum film was formed, a resist pattern was formed by the photolithography technology so that the cathode 6 has a width of 3 μm in the Y-direction. Thereafter, the molybdenum film was processed using a dry etching technique to form the cathode 6. A CF₄-based gas was used as a processing gas at that time. Thereafter, the Ni release layer 20 educed on the gate 5 was removed using an etchant containing iodine and potassium iodide to release the molybdenum film 6C on the gate 5 (FIG. 6G).

Lastly, Cu with a thickness of 500 nm was deposited by sputtering and is patterned to form the cathode electrode 2, thus producing the electron-emitting device of this example (FIG. 6H).

The characteristics of the electron-emitting device of this example were evaluated with the configuration in FIG. 3A. Evaluation conditions were as follows: the driving voltage (Vf) was set at 21 V; the anode apply voltage (Va) was set at 11.8 kV; and the interval between the anode and the electron-emitting device was set at 1.7 mm. As a result, the mean device current If was 127 μA, the electron emission current Ie was 28 μA, and the mean electron emission efficiency η was 18%, so that an electron-emitting device with sufficient emission current and high efficiency was provided.

After the electron emission characteristics were determined, observation of the electron-emitting device using a scanning electron microscope (SEM) showed that the distance d1 between the protrusions 16 of the cathode 6 and the gate 5 was 5.0 nm. As shown in FIGS. 1D and 2, the plurality of protrusions 16 of the cathode 6 were provided along the corner 32 of the insulating member 3 (in the Y-direction), and the individual protrusions 16 were provided in one-to-one correspondence with the plurality of protrusions 15 of the gate 5. As shown in FIG. 2 and FIGS. 7A and 7B, the cathode 6 covered, of the corner 32 of the insulating member 3, portions between the protrusions 16. The cathode 6 also covered, of the side surface of the insulating member 3, portions between the protrusions 16. The portions 6b of the cathode 6 in FIG. 7B were thinner and had higher resistance than the portions 6a of the cathode 6. The distance d1 between the protrusions 16 of the cathode 6 and the gate 5 and the period T1 and the amplitude A1 of the protrusions 15 of the gate 5 satisfied the relationships, A1≧0.5×d1 and 10×d1≧T1.

Table 1 shows the evaluation results of the electron emission characteristics of electron-emitting devices formed in the same procedure, with the amplitude A1 and the period T1 of the protrusions 15 of the gate 5 varied. The width W1 of the protrusions 15 of the gate 5 was set at half of the period T1. In any case, electron-emitting devices having higher efficiency η than an electron-emitting device of comparative example 1, described later, were obtained.

In this example, the relationship among A1, T1, and d1 satisfied A1≧0.5×d1 and 10×d1≧T1, so that electron-emitting devices having high efficiency η were obtained.

### Comparative Example 1

An electron-emitting device in which the gate 5 has not the protrusions 15 was manufactured as Comparative Example 1. Since the basic manufacturing method is the same as in Example 1, only differences from Example 1 will be described here. In this example, the gate 5 was manufactured without the process using FIB shown in FIG. 6C.

The characteristics of the electron-emitting device of this comparative example were evaluated under the same conditions as for the electron-emitting devices of Example 1, as in Example 1, the mean device current If was 30 μA, the electron emission current Ie was 4 μA, and the mean electron emission efficiency η was 11%.

After the electron emission characteristics were determined, observation of the electron-emitting device using an SEM showed that the distance d1 between the protrusions 16 of the cathode 6 and the gate 5 was 5.0 nm. The distance d1 between the protrusions 16 and the gate 5 was constant along the corner 32, and the plurality of protrusions 16 dotted along the corner 32 (in the Y-direction) as in FIG. 1D were not formed. The electron-emitting device of Comparative Example 1 could not obtain a sufficient electron emission efficiency η as compared with the electron-emitting devices of Example 1. This seems to be because the emitted electrons collided with the gate 5, so that they could not reach the anode 11. Another reason why a sufficient electron emission efficiency η could not be obtained seems to be because the cathode 6 has not the depressions and protrusions along the corner 32 as in FIG. 1D. Temporal changes in emission current of the electron-emitting device of this comparative example were larger than those of the electron-emitting device of Example 1.

TABLE 1

| | | | | | | Efficiency |
|---|---|---|---|---|---|---|
| | A1(nm) | T1(nm) | d1(nm) | If(μA) | Ie(μA) | (%) |
| Example 1 | 6.0 | 12.0 | 5.0 | 127 | 28 | 18 |
| | 6.0 | 50.0 | 5.0 | 60 | 9 | 13 |
| | 15.0 | 12.0 | 5.0 | 96 | 26 | 21 |
| Comparative | | | 5.0 | 30 | 4 | 11 |
| example | | | | | | |

### Example 2

Next, an example in which an electron-emitting device in which the distance d1 between the protrusions 16 of the cathode 6 and the gate 5 was set larger than the electron-emitting device of Example 1 was manufactured will be shown. Since the basic manufacturing method is the same as in Example 1, only differences from Example 1 will be described here.

In this example, the growth of the protrusions 16 of the cathode 6 was inhibited by reducing the amount of molybdenum deposited as a cathode material. In this example, the molybdenum film was deposited on the surface of the substrate 1 into a thickness of 10 nm. The reduction of the amount of molybdenum deposited corresponds to an increase in distance d1.

As a result of evaluation of the electron emission characteristics of the electron-emitting device of this example under the same conditions in Example 1, the mean device current If was 2 nA, the electron emission current Ie was 0.4 nA, and the mean electron-emitting device was 18%. Although the efficiency η was hither than that of the electron-emitting device of Comparative Example 1, a sufficient emission current like the electron-emitting device of Example 1 could not obtained.

When the gap 8 was observed using an SEM, as in Example 1, after determination of the electron emission characteristics, the distance d1 between the protrusions 16 of the cathode 6 and the gate 5 was 15.3 nm. The major reason that the current Ie and the device current If were lower than those of the electron-emitting device of Example 1 seems to be because the value of d1 was significantly larger than the value of d1 of the electron-emitting device of Example 1.

As shown in FIGS. 1D and 2, the protrusions 16 of the cathode 6 were provided along the corner 32 of the insulating member 3 (in the Y-direction), and the protrusions 16 of the cathode 6 and the protrusions 15 of the gate 5 faced each other in one-to-one correspondence. However, the protrusions and depressions along the corner 32, shown in FIG. 1D, are smaller than those of the electron-emitting device of Example 1. This also seems to be the reason that the current Ie and the device current If were lower than those of the electron-emitting device of Example 1.

In this example, the period T1 of the protrusions 15 of the gate 5 satisfied 10×d1≧T1, and the amplitude A1 of the protrusions 15 of the gate 5 satisfied A1≧0.5×d1, but the distance d1 did not satisfy 10≧d1≧1. The reason why sufficient emission current could not be obtained seems to be because the distance d1 between the protrusions 16 of the cathode 6 and the gate 5 exceeds 10 nm.

### Example 3

Next, Example 3 in which the phases of the protrusions 15 of the gate 5 and the protrusions 16 of the cathode 6 are shifted by half period will be described.

In this example, the electron-emitting device with the configuration that is schematically shown in FIG. 8 was manufactured. Since the basic manufacturing method is the same as that of Example 1, only differences from Example 1 will be described here.

In this example, protrusions were manufactured on the side surface 5a of the gate 5 but were not manufactured on the side surface 3d of the insulating layer 3b using FIB in the process described using FIG. 6C (FIG. 9). The FIB process was performed so that the amplitude A1 of the protrusions 15 of the gate 5 reaches 6.3 nm and the interval W2 between two adjacent protrusions 15 reaches 12.5 nm. The other processes for manufacturing the electron-emitting device are the same as in Example 1.

After the electron-emitting device was formed by the above method, the electron emission characteristics were evaluated under the same conditions as in Example 1. As a result, the mean device current If was 10 μA, the electron emission current Ie was 16 μA, and the mean electron emission efficiency η was 61%, thus providing an electron-emitting device with sufficient emission current and high efficiency η. The reason that the electron emission efficiency η of the electron-emitting device of this example was higher than the efficiency η of the electron-emitting devices of Examples 1 and 2 seems to be as follows: electric flux lines directly above the protrusions 16 of the cathode 6 did not directly travel to the gate 5, but traveled upward perpendicularly to the substrate (toward the anode 11), thus increasing nonscattered electrons that do not collide with the gate 5.

Observation using an SEM after the characteristics were determined showed that the distance d1 between the protrusions 16 of the cathode 6 and the gate 5 was 5.5 nm. Thus, the major reason that the current Ie and the device current If were lower than those of the electron-emitting device of Example 1 seems to be because the value of d1 was larger than the value of d1 of the electron-emitting device of Example 1.

As shown in FIG. 1D, the plurality of protrusions 16 of the cathode 6 were provided along the corner 32 of the insulating member 3 (in the Y-direction), and as shown in FIG. 8, the individual protrusions 16 of the cathode 6 were disposed between two adjacent protrusions 15 of the gate 5. The relationship among A1, W2, and d1 satisfied d1≦W2≦3×d1 and A1≧d1.

Table 2 shows the evaluation results of the electron emission characteristics with the sizes W2 and A1 varied by the FIB process in the same procedure.

In any case, electron-emitting devices with higher electron emission efficiency η than that in Comparative Example 1 could be obtained. The relationship among W2, A1, and d1 satisfied d1≦W2≦3×d1 and A1≧d1.

### Example 4

Example 4 in which the value W2 is higher than that of Example 3 is shown. Since the basic manufacturing method is the same as that of Example 3, only differences from Example 3 will be described here. In this example, the FIB process was performed so that the amplitude A1 of the protrusions 15 of the gate 5 reaches 6 nm, and the interval W2 reaches 30 nm. The other processes for manufacturing the electron-emitting device are the same as in Example 3.

After the electron-emitting device was formed by the above method, the electron emission characteristics of the electron-emitting device of this example were evaluated under the same conditions as in Example 1. As a result, the device current If was 2 μA, the electron emission current Ie was 1 μA, and the mean electron emission efficiency η was 36%. The electron emission efficiency η was lower than that of the electron-emitting device of Example 3 but is higher than that of the electron-emitting device of Example 1.

Observation using an SEM after the characteristics were determined showed that the mean interval d1 between the protrusions 16 and the gate 5 was 5.5 nm. As shown in FIG. 1D, the plurality of protrusions 16 of the cathode 6 were disposed along the corner 32 of the insulating member 3 (in the Y-direction), and as shown in FIG. 8, the individual protrusions 16 of the cathode 6 were disposed between two adjacent protrusions 15 of the gate 5. In this example, the relationship among W2, A1, and d1 satisfies A1≧d1 but does not satisfy d1≦W2≦3×d1. In this example, the reason that the electron emission efficiency η was lower than that of the electron-emitting device of Example 3 seems to be because the effect of the protrusions 15 was decreased due to the large value of W2.

TABLE 2

| | | | | | | Efficiency |
|---|---|---|---|---|---|---|
| | A1(nm) | T1(nm) | d1(nm) | If(μA) | Ie(μA) | (%) |
| Example 3 | 5.5 | 11.0 | 5.4 | 11 | 16 | 59 |
| | 6.3 | 12.5 | 5.5 | 10 | 16 | 61 |
| | 6.9 | 13.7 | 5.9 | 3 | 7 | 71 |
| Example 4 | 6.0 | 33.0 | 5.5 | 2 | 1 | 36 |

### Comparative Example 2

In this comparative example, the portions 6b of the cathode 6 of the electron-emitting device manufactured in Example 1, shown in FIG. 7B, were removed using FIB. Measurement of the electron emission characteristics as in Example 1 showed that the initial electron emission current Ie was the same as in Example 1. However, temporal changes in electron emission current Ie were larger than the electron-emitting device of Example 1.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-222513, filed on Sep. 28, 2009, which is hereby incorporated by reference herein in its entirety.

What is claimed is:

1. An electron-emitting device comprising:
an insulating member including an upper surface and a side surface connected to the upper surface;
a cathode extending from a first part of the upper surface to the side surface and including a first plurality of protrusions disposed along a boundary between the upper surface and the side surface; and
a gate including a base connected to a second part of the insulating member and a second plurality of protrusions each protruding from the base toward the cathode and forming a gap between the second plurality protrusions and the first plurality of protrusions.

2. The electron-emitting device according to claim 1, wherein
the insulating member includes a first insulating layer having the upper surface and the side surface and a second insulating layer stacked on part of the upper surface;
the base is connected to the second insulating layer; and
the cathode is provided on the side surface and covers another part of the upper surface.

3. The electron-emitting device according to claim 1, wherein the first plurality of protrusions of the cathode are provided such that a distance between the cathode and the gate is shortest between the first plurality of protrusions and the second plurality of protrusions.

4. The electron-emitting device according to claim 3, wherein relationships A1≧0.5×d1 and 10×d1≧T1 are satisfied, where A1 [m] is the distance from the base to ends of the second protrusions, d1 [m] is a shortest distance between the protrusions of the cathode and the gate, and T1 [m] is a period of the second plurality of protrusions.

5. The electron-emitting device according to claim 3, wherein the second plurality of protrusions and the first plurality of protrusions are disposed in one-to-one correspondence.

6. The electron-emitting device according to claim 1, wherein the first plurality of protrusions are provided so as to face portions between two adjacent protrusions of the second plurality of protrusions.

7. The electron-emitting device according to claim 6, wherein relationships d1≦W2≦3×d1 and A1≧d1 are satisfied, where W2 [m] is an interval between two adjacent protrusions of the second plurality of protrusions, A1 [m] is a distance from the base to the ends of the second protrusions, and d1 [m] is a shortest distance between the cathode and the gate.

8. The electron-emitting device according to claim 1, wherein a shortest distance d1 [m] between the cathode and the gate is between 1 nm and 10 nm.

9. A display panel comprising the electron-emitting device according to claim 1 and a light-emitting member that emits light when irradiated with electrons emitted from the device.

10. An image display apparatus comprising:
a display unit including a display panel and a circuit that generates a driving signal for driving the display panel in response to an input signal; and
a unit that outputs the input signal to the circuit as an image signal,
wherein the display panel is the display panel according to claim 9.
